(19) United States
(12) Patent Application Publication
(10) Pub. No.: US 2026/0175593 A1
(43) Pub. Date: Jun. 25, 2026

(54) TREATMENT AGENT SOLUTION APPLICATION APPARATUS AND IMAGE FORMING APPARATUS

(71) Applicants: Takayuki SEKI, Kanagawa (JP); Kohki ASADA, Tokyo (JP); Kanta FURUYA, Tokyo (JP); Kenji NOZAWA, Kanagawa (JP); Genichiroh KAWAMICHI, Kanagawa (JP); Takehiro NAKAMURA, Ibaraki (JP); Hirotaka KOBAYASHI, Kanagawa (JP); Isao MATSUSHIMA, Kanagawa (JP); Takashi EBIHARA, Ibaraki (JP)

(72) Inventors: Takayuki SEKI, Kanagawa (JP); Kohki ASADA, Tokyo (JP); Kanta FURUYA, Tokyo (JP); Kenji NOZAWA, Kanagawa (JP); Genichiroh KAWAMICHI, Kanagawa (JP); Takehiro NAKAMURA, Ibaraki (JP); Hirotaka KOBAYASHI, Kanagawa (JP); Isao MATSUSHIMA, Kanagawa (JP); Takashi EBIHARA, Ibaraki (JP)

(21) Appl. No.: 19/408,460

(22) Filed: Dec. 4, 2025

(30) Foreign Application Priority Data
Dec. 19, 2024 (JP) 2024-224110

(51) Int. Cl. B41J 11/00

(52) U.S. Cl. CPC B41J 11/0015

(57) ABSTRACT

A treatment agent solution application apparatus is mounted on an image forming apparatus. The treatment agent solution application apparatus includes an application roller, a pressurizing roller, a supply roller, and a first controller. The application roller is configured to apply a treatment agent to a conveyed recording medium. The pressurizing roller is configured to apply pressure to the application roller. The supply roller is configured to supply the treatment agent to the application roller. The first controller is configured to rotate the application roller for a predetermined rotation time during a period from acquisition of job information by the image forming apparatus to arrival of the recording medium at the application roller.

### CROSS-REFERENCE TO RELATED APPLICATION

The present application claims priority under 35 U.S.C. § 119 to Japanese Patent Application No. 2024-224110, filed on Dec. 19, 2024. The contents of which are incorporated herein by reference in their entirety.

### BACKGROUND OF THE INVENTION

### 1. Field of the Invention

The present invention relates to a treatment agent solution application apparatus and an image forming apparatus.

### 2. Description of the Related Art

A technology for improving image quality by applying a treatment agent to a medium during an image forming process in an image forming apparatus that forms and prints an image on the medium by an inkjet system is known, and, in general, a configuration of applying the treatment agent, before the image forming process, by an application roller when the medium that is supported by the application roller containing the treatment agent and a conveying roller that is located opposite to the application roller across the medium passes by the application roller is used. In this case, image quality is affected by an amount of the applied treatment agent, and therefore, it is demanded to uniformly apply the treatment agent onto the medium.

As a technology for applying the treatment agent as described above, a certain configuration is disclosed in which an application roller drive control unit performs control such that a circumferential speed of an application roller becomes lower than a conveying speed of a subject recording medium while the subject recording medium is being conveyed, and a pressurizing roller, when the circumferential speed of the application roller that is controlled by the application roller drive control unit becomes equal to or higher than a smoothing rotational speed of the application roller, comes into pressure contact with the application roller to sandwich and convey the subject recording medium between the application roller and the pressurizing roller and transfer a treatment liquid to the subject recording medium so as to prevent looseness of the subject recording medium at a rear end of the treatment liquid application unit and realize an appropriate process (for example, Japanese Unexamined Patent Application Publication No. 2014-024224).

However, in the related technology, the application roller that includes an elastic layer on an outer circumference thereof is sandwiched between a fixed roller and the pressurizing roller and a nip is formed between the application roller and each of the fixed roller and the pressurizing roller; therefore, when the application roller is left in a non-rotating state, recesses due to nips at two positions with a pitch of 180 degrees remain in the application roller, so that when a medium is inserted in the above-described nips and the application roller rotates in accordance with a line speed of the medium, an amount of the treatment agent that is applied to the above-described recesses increases and application unevenness in a banding manner with a pitch of a half of the circumference of the application roller occurs, which is a problem.

### SUMMARY OF THE INVENTION

According to an aspect of the present invention, a treatment agent solution application apparatus is mounted on an image forming apparatus. The treatment agent solution application apparatus includes an application roller, a pressurizing roller, a supply roller, and a first controller. The application roller is configured to apply a treatment agent to a conveyed recording medium. The pressurizing roller is configured to apply pressure to the application roller. The supply roller is configured to supply the treatment agent to the application roller. The first controller is configured to rotate the application roller for a predetermined rotation time during a period from acquisition of job information by the image forming apparatus to arrival of the recording medium at the application roller.

### BRIEF DESCRIPTION OF THE DRAWINGS

FIG. 1 is a diagram illustrating an example of an overall configuration of an image forming apparatus according to one embodiment;

FIG. 2 is a diagram illustrating another example of the overall configuration of the image forming apparatus according to one embodiment;

FIG. 3 is a diagram illustrating an example of a configuration of a pre-application unit of the image forming apparatus according to one embodiment;

FIG. 4 is a diagram illustrating an example of a configuration of an application unit of the pre-application unit of the image forming apparatus according to one embodiment;

FIG. 5 is a diagram illustrating an example of a hardware configuration of the image forming apparatus according to one embodiment;

FIG. 6 is a diagram for explaining control operation of an application roller in the application unit of the pre-application unit of the image forming apparatus according to one embodiment;

FIG. 7 is a diagram illustrating an example of a functional block configuration of the image forming apparatus according to one embodiment;

FIG. 8 is a diagram illustrating a preparation state before application of a treatment agent in an application unit of a pre-application unit of a related image forming apparatus;

FIG. 9 is a diagram illustrating a state at the time of applying the treatment agent in the application unit of the pre-application unit of the related image forming apparatus;

FIG. 10 is a diagram illustrating a state in which application unevenness in a banding manner occurs in a medium to which the treatment agent is applied by the pre-application unit of the related image forming apparatus;

FIG. 11 is a diagram illustrating a non-operation state of the application unit of the pre-application unit of the image forming apparatus according to one embodiment;

FIG. 12 is a diagram illustrating a preparation state before application of a treatment agent in the application unit of the pre-application unit of the image forming apparatus according to one embodiment;

FIG. 13 is a diagram illustrating a state at the time of applying the treatment agent in the application unit of the pre-application unit of the image forming apparatus according to one embodiment;

FIG. 14 is a diagram illustrating a state of a medium to which the treatment agent is applied by the pre-application unit of the image forming apparatus according to one embodiment; and

FIG. 15 is a diagram illustrating an example of a functional block configuration of an image forming apparatus according to a first modification.

The accompanying drawings are intended to depict exemplary embodiments of the present invention and should not be interpreted to limit the scope thereof. Identical or similar reference numerals designate identical or similar components throughout the various drawings.

### DESCRIPTION OF THE EMBODIMENTS

The terminology used herein is for the purpose of describing particular embodiments only and is not intended to be limiting of the present invention.

As used herein, the singular forms “a”, “an” and “the” are intended to include the plural forms as well, unless the context clearly indicates otherwise.

In describing preferred embodiments illustrated in the drawings, specific terminology may be employed for the sake of clarity. However, the disclosure of this patent specification is not intended to be limited to the specific terminology so selected, and it is to be understood that each specific element includes all technical equivalents that have the same function, operate in a similar manner, and achieve a similar result.

An embodiment of the present invention will be described in detail below with reference to the drawings.

An embodiment has an object to provide a treatment agent solution application apparatus and an image forming apparatus that prevent occurrence of application unevenness of a treatment agent in a banding manner on a recording medium and improve uniformity of application of the treatment agent.

Embodiments of a treatment agent solution application apparatus and an image forming apparatus according to the present invention will be described in detail below with reference to the drawings. Further, the present invention is not limited by the embodiments described below, and components in the embodiments below include one that can be easily thought of by a person skilled in the art, one that is practically identical, and one that is within an equivalent range. Furthermore, within a range of not departing from the gist of the embodiments below, various omission, replacement, alteration, and combinations of the components may be made.

### Overall Configuration of Image Forming Apparatus

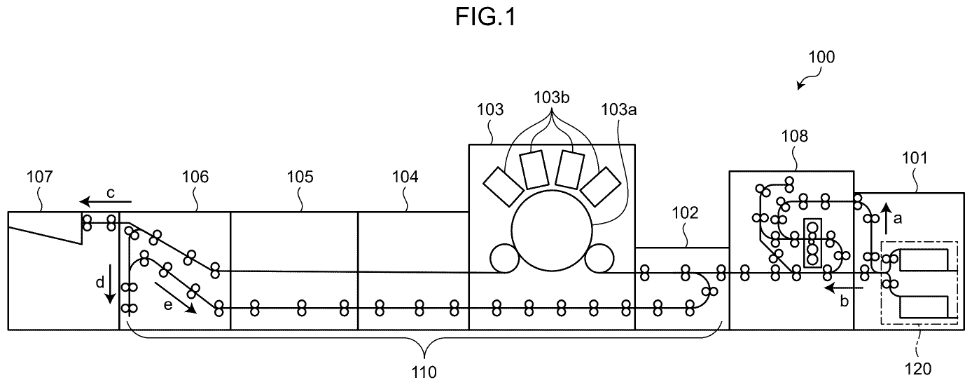

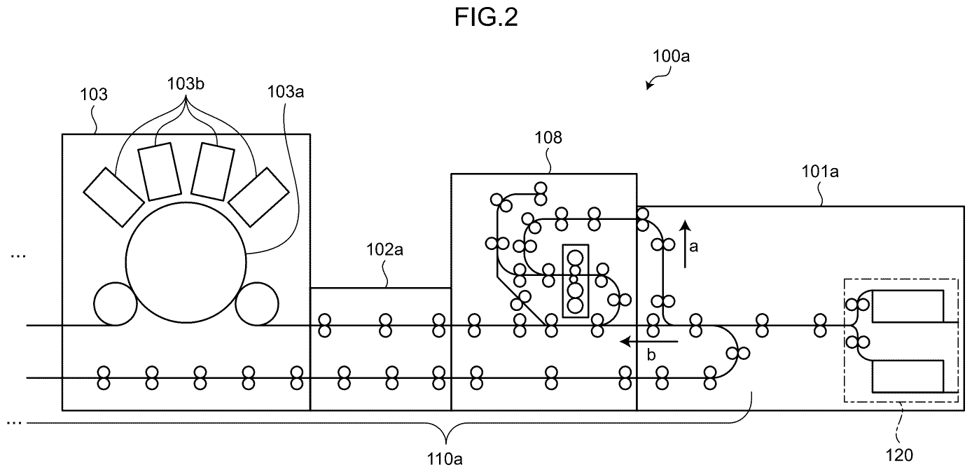

FIG. 1 is a diagram illustrating an example of an overall configuration of an image forming apparatus according to one embodiment. FIG. 2 is a diagram illustrating another example of the overall configuration of the image forming apparatus according to one embodiment. With reference to FIG. 1 and FIG. 2, an overall configuration of an image forming apparatus 100 according to one embodiment will be described.

The image forming apparatus 100 illustrated in FIG. 1 is a commercial printing machine that performs image formation by an inkjet method on a medium (recording medium), such as a sheet of paper. The image forming apparatus 100 includes a paper feed unit 101, a pre-application unit 108, a registration unit 102, an image forming unit 103, a drying unit 104, a cooling unit 105, an inverting unit 106, and a paper ejection unit 107.

The paper feed unit 101 is a unit that separates and conveys media one by one from a paper feed tray 120. The separated and conveyed medium is fed to the pre-application unit 108. The paper feed unit 101 is able to change a medium conveying path depending on whether or not the pre-application unit 108 performs pre-application of a treatment agent, conveys a medium along a path b illustrated in FIG. 1 when the pre-application is not performed, and conveys a medium along a path a when the pre-application is performed. Meanwhile, in the present embodiment, it is assumed that the pre-application unit 108 performs pre-application on a medium, and therefore, explanation will be given based on the assumption that the paper feed unit 101 conveys a medium along the path a.

The pre-application unit 108 is a unit (treatment agent solution application apparatus) for applying a treatment agent for pre-application onto one surface or both surfaces of the medium that is conveyed and fed from the paper feed unit 101 along the path a. The medium that is subjected to the pre-application of the treatment agent by the pre-application unit 108 is conveyed to the registration unit 102.

The registration unit 102 is a unit that appropriately corrects a posture of the medium that is conveyed from the pre-application unit 108. The medium for which the posture is corrected by the registration unit 102 is conveyed to the image forming unit 103.

The image forming unit 103 is a unit that forms and prints an image by ejecting ink to the medium that is conveyed from the registration unit 102. The image forming unit 103 includes, as illustrated in FIG. 1, an image formation conveying drum 103a and inkjet heads 103b.

The image formation conveying drum 103a is a conveying drum for conveying, in a rotating manner, the medium conveyed from the registration unit 102 toward the inkjet heads 103b. The inkjet heads 103b are ejection heads that eject ink to the medium conveyed by the image formation conveying drum 103a to form and print an image.

The medium on which the image is formed and printed by the image forming unit 103 is conveyed to the drying unit 104.

The drying unit 104 is a unit that dries the medium that is conveyed from the image forming unit 103. Meanwhile, in the example of the image forming apparatus 100 illustrated in FIG. 1, the single drying unit 104 is provided, but embodiments are not limited to this example, and it may be possible to provide a plurality of drying units in accordance with dry conditions. The medium that is dried by the drying unit 104 is conveyed to the cooling unit 105.

The cooling unit 105 is a unit that cools the medium that is dried and conveyed by the drying unit 104. The medium that is cooled by the cooling unit 105 is conveyed to the inverting unit 106.

The inverting unit 106 is a unit that, when double-sided printing is performed on the medium that is conveyed from the cooling unit 105, inverts the medium on a path d by switchback and conveys the medium from a path e to a duplex conveying unit 110 as illustrated in FIG. 1. The medium that is conveyed to the double-sided conveying path 110 is re-fed to the registration unit 102, and an image is formed and printed on a second surface that is a back surface of a first surface on which the image is already formed and printing by the image forming unit 103. Further, when single-sided printing is performed on the medium that is conveyed from the cooling unit 105 or when the double-sided printing is already performed, the inverting unit 106 conveys the medium to the paper ejection unit 107 through a path c as illustrated in FIG. 1.

The paper ejection unit 107 is a unit that ejects the medium that is conveyed from the inverting unit 106 onto a paper ejection tray.

Meanwhile, in the image forming apparatus 100 illustrated in FIG. 1, the example is described in which when the medium that is to be subjected to the double-sided printing is inverted by the inverting unit 106, the medium is re-fed by the registration unit 102, that is, on a downstream side of the pre-application unit 108; however, as in an image forming apparatus 100a illustrated in FIG. 2, it may be possible to adopt a configuration in which, as a position at which the medium is re-fed, the medium is re-fed on an upstream side of the pre-application unit 108. In the image forming apparatus 100a illustrated in FIG. 2, an example is illustrated in which the medium is re-fed by a paper feed unit 101a on the upstream side of the pre-application unit 108. In FIG. 2, the configurations of the units on a downstream side of the image forming unit 103 are the same as those illustrated in FIG. 1, and therefore, illustration thereof is omitted. The medium that is separated and conveyed from the paper feed tray 120 in the paper feed unit 101a is subjected to pre-application of a treatment agent by the pre-application unit 108, subjected to posture adjustment by a registration unit 102a, and transferred to the image forming unit 103. In the case of the double-sided printing, similarly to FIG. 1, the medium that is inverted by the inverting unit 106 passes through a double-sided conveying path 110a, re-fed by the paper feed unit 101a on the upstream side of the pre-application unit 108, re-conveyed to the pre-application unit 108, subjected to, in the pre-application unit 108, pre-application of a treatment agent on the second surface that is a back surface of the first surface on which the pre-application and image formation and printing are already performed, and subjected to image formation and printing on the second surface by the image forming unit 103.

### Configuration of Pre-Application Unit

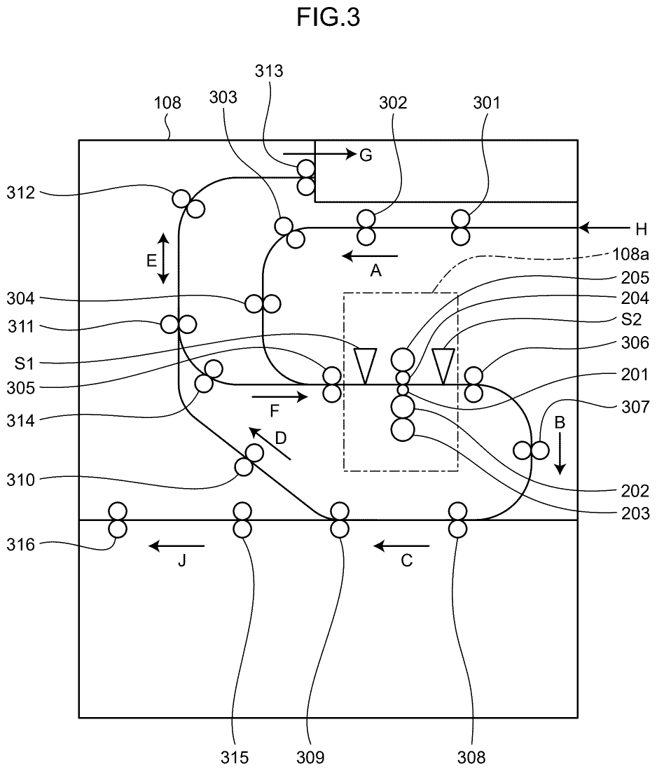

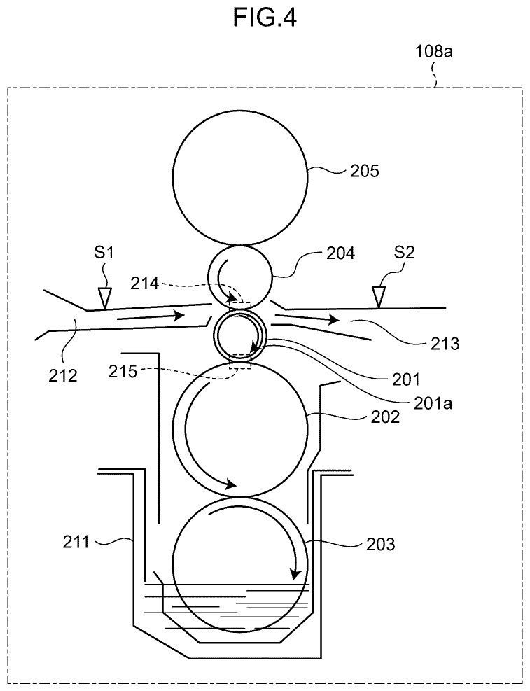

FIG. 3 is a diagram illustrating an example of a configuration of the pre-application unit of the image forming apparatus according to one embodiment. FIG. 4 is a diagram illustrating an example of a configuration of the application unit of the pre-application unit of the image forming apparatus according to one embodiment. With reference to FIG. 3 and FIG. 4, a configuration of the pre-application unit 108 of the image forming apparatus 100 according to the present embodiment will be described.

As illustrated in FIG. 3, the pre-application unit 108 includes an application unit 108a, entry rollers 301 to 305, exit rollers 306 to 309, purge rollers 310 to 313, a re-entry roller 314, and exit rollers 315 and 316.

The application unit 108a is a device that applies a treatment agent onto a medium that has entered the pre-application unit 108 in a direction H and that has been conveyed by the entry rollers 301 to 305. A configuration of the application unit 108a will be described in detail later.

The entry rollers 301 to 305 are conveying rollers that convey the medium that has entered the pre-application unit 108 in the direction H to the direction A, and further convey the medium to the application unit 108a.

The exit rollers 306 to 309 are rollers that convey the medium to which the treatment agent is applied by the application unit 108a, along directions B and C illustrated in FIG. 3. When the treatment agent is to be applied to both surfaces of the medium, the treatment agent is applied to the first surface of the medium in the application unit 108a, the medium passes by the exit rollers 306 to 309, and the medium is conveyed by the purge rollers 310 along a direction D by a bifurcating claw (not illustrated). In contrast, when the treatment agent is to be applied to one surface of the medium, the treatment agent is applied to the first surface of the medium in the application unit 108a, the medium passes through the exit rollers 306 to 309, and the medium is conveyed to the registration unit 102 along a direction J by the exit rollers 315 and 316 and the bifurcating claw (not illustrated).

The purge roller 310 is a conveying roller that conveys the medium with the first surface to which the treatment agent is applied to the purge rollers 311 to 313 for switch-back.

The purge rollers 311 to 313 are conveying rollers that convey the medium, which has been conveyed by the purge roller 310, along directions E and G illustrated in FIG. 3 for switch-back. The medium that is switched back by the purge rollers 311 to 313 is re-conveyed to the application unit 108a along a direction F by the re-entry rollers 314, and the treatment agent is applied to the second surface. Meanwhile, the path along the directions E and G through the purge rollers 311 to 313 may be used as a purge path.

The re-entry roller 314 is a conveying roller that conveys the medium that has been switched back by the purge rollers 311 to 313 to the application unit 108a along the direction F.

The exit rollers 315 and 316 are conveying rollers that convey the medium that has been conveyed by the exit rollers 307 to 309 along the directions B and C to the registration unit 102 along a direction J.

Meanwhile, as in the image forming apparatus 100a illustrated in FIG. 2, when the medium that has been inverted by the inverting unit 106 is re-fed on the upstream side of the pre-application unit 108, it may be possible to apply the treatment agent onto the both surfaces of the medium in the pre-application unit 108 before the medium is conveyed to the registration unit 102a; however, it may be possible to apply the treatment agent onto only the first surface in the pre-application unit 108, convey the medium to the registration unit 102a, form and print an image on the first surface, convey the medium through the double-sided conveying path 110a, and apply the treatment agent onto the second surface in the pre-application unit 108. In this case, it is not needed to switch back the medium in the pre-application unit 108, and therefore, the pre-application unit 108 need not include the purge rollers 310 to 313 and the re-entry roller 314.

A specific configuration of the application unit 108a of the pre-application unit 108 will be described below with reference to FIG. 4.

As illustrated in FIG. 4, the application unit 108a includes an application roller 201, a fixed roller 202, a squeeze roller 203, a pressurizing roller 204, a pressing roller 205, a treatment agent solution pan 211, an entry sensor S1, and an exit sensor S2. As illustrated in FIG. 4, the squeeze roller 203, the fixed roller 202, the application roller 201, the pressurizing roller 204, and the pressing roller 205 are arranged in this order from below.

The application roller 201 is a roller that applies, by rotation operation, a liquid treatment agent that is supplied from a surface of the fixed roller 202 to a lower surface of the medium that is conveyed from an upstream conveying path 212. A cored bar of the application roller 201 is made of, for example, SUS303. Further, the application roller 201 includes, as illustrated in FIG. 4, an elastic layer 201a on an outer circumference thereof. The elastic layer 201a is made of, for example, polychloroprene.

The fixed roller 202 is a supply roller that supplies, by rotation operation, the treatment agent that is supplied from the squeeze roller 203 to the application roller 201. The fixed roller 202 is, for example, a metal roller that is made of SUS303.

The squeeze roller 203 is a roller that is impregnated with the treatment agent that is filled in the treatment agent solution pan 211, and supplies, by rotation operation, the treatment agent to the fixed roller 202. Further, the squeeze roller 203 has a function to stir the treatment agent that is filled in the treatment agent solution pan 211. Furthermore, the squeeze roller 203 includes an elastic layer that is made of polychloroprene or the like on an outer circumference thereof, and includes a cored bar that is made of, for example, SUS303.

The pressurizing roller 204 is a roller that applies pressure from above to the application roller 201. Further, when the medium is conveyed from the upstream conveying path 212 to the application roller 201, the pressurizing roller 204 applies pressure to the medium against the application roller 201. The pressurizing roller 204 is, for example, a metal roller that is made of SUS303.

The pressing roller 205 is a roller that applies a load to the pressurizing roller 204 and the application roller 201 in a downward direction and is driven to rotate by rotation of the pressurizing roller 204. Further, the pressing roller 205 includes an elastic layer that is made of polychloroprene or the like on an outer circumference thereof, and includes a cored bar that is made of, for example, SUS303.

The medium that is conveyed from the upstream conveying path 212 is subjected to application of a treatment liquid by the application roller 201, and thereafter conveyed to the exit roller 306 illustrated in FIG. 3 through a downstream conveying path 213. Further, the application roller 201, the fixed roller 202, the squeeze roller 203, and the pressurizing roller 204 as described above are rotated by a motor 206 (to be described later) that is the same drive source (to be described later). Of the rollers as described above, the application roller 201 and the squeeze roller 203 rotate clockwise when viewed in the direction toward the sheet of FIG. 4, and the fixed roller 202 and the pressurizing roller 204 rotate counterclockwise when viewed in the direction toward the sheet of FIG. 4.

The treatment agent solution pan 211 is a pan for storing the liquid treatment agent.

The entry sensor S1 is a sensor that detects the medium that is conveyed through the upstream conveying path 212. The exit sensor S2 is a sensor that detects the medium to which the treatment agent is applied by the application roller 201 and which is conveyed through the downstream conveying path 213.

In the configuration of the application unit 108a as described above, as illustrated in FIG. 4, a nip portion 214 is formed between the application roller 201 that includes the elastic layer 201a on the outer circumference thereof and the pressurizing roller 204, and a nip portion 215 is formed between the application roller 201 and the fixed roller 202. In the nip portion 214, the elastic layer 201a of the application roller 201 receives a nip pressure from the pressurizing roller 204 and is deformed into a recessed shape. Further, in the nip portion 215, the elastic layer 201a of the application roller 201 receives nip pressure from the fixed roller 202 and is deformed into a recessed shape. The medium that is conveyed from the upstream conveying path 212 passes through the nip portion 214, and is subjected to application of the treatment agent from the application roller 201.

### Hardware Configuration of Image Forming Apparatus

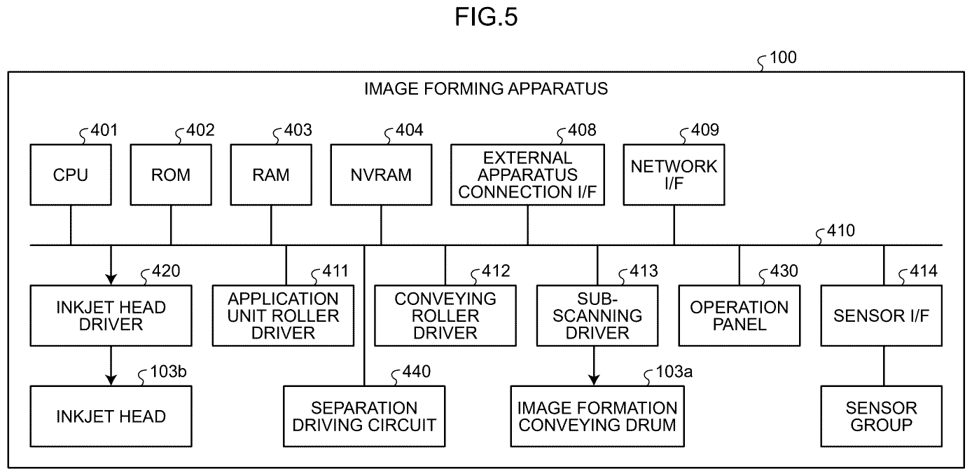

FIG. 5 is a diagram illustrating an example of a hardware configuration of the image forming apparatus according to one embodiment. With reference to FIG. 5, a hardware configuration of the image forming apparatus 100 according to the present embodiment will be described.

As illustrated in FIG. 5, the image forming apparatus 100 includes a Central Processing Unit (CPU) 401, a Read Only memory (ROM) 402, a Random Access Memory (RAM) 403, a Non Volatile Random Access Memory (NVRAM) 404, an external apparatus connection I/F 408, a network I/F 409, an application unit roller driver 411, a conveying roller driver 412, a sub-scanning driver 413, a sensor I/F 414, an inkjet head driver 420, an operation panel 430, and a separation driving circuit 440.

The CPU 401 is an arithmetic device that controls the entire image forming apparatus 100. The ROM 402 is a non-volatile storage device for storing a program, such as an Initial Program Loader (IPL). The RAM 403 is a volatile storage device that is used as a work area of the CPU 401.

The NVRAM 404 is a non-volatile storage device that stores therein various kinds of data, such as a program, and retains the various kinds of data while power of the image forming apparatus 100 is turned off.

The external apparatus connection I/F 408 is an interface that is connected to an external apparatus, such as a Personal Computer (PC), by a Universal Serial Bus (USB) cable or the like, and exchanges a control signal, data to be printed, or the like with the external apparatus.

The network I/F 409 is an interface that is compliant with a Transmission Control Protocol/Internet Protocol (TCP/IP) for performing data communication via the Internet, a Local Area Network (LAN), or the like. Further, the network I/F 409 may be an interface for wired communication complaint with Ethernet (registered trademark) or the like, or may be an interface for wireless communication compliant with Wi-Fi (registered trademark) or the like.

The application unit roller driver 411 is a driving circuit for driving the motor 206 that rotates the application roller 201, the fixed roller 202, the squeeze roller 203, and the pressurizing roller 204 of the pre-application unit 108.

The conveying roller driver 412 is a driving circuit for rotates each of the entry rollers 301 to 305, the exit rollers 306 to 309, the purge rollers 310 to 313, the re-entry roller 314, and the exit rollers 315 and 316 of the pre-application unit 108 independently.

The sub-scanning driver 413 is a driving circuit for rotating the image formation conveying drum 103a of the image forming unit 103 to rotate to convey the medium in a conveying direction, that is, in a sub-scanning direction.

The sensor I/F 414 is an interface for receiving a signal that is detected by a sensor group, such as the entry sensor S1 and the exit sensor S2.

The inkjet head driver 420 is a driving circuit for controlling ejection operation of the inkjet heads 103b.

The operation panel 430 is a device that displays setting information, various kinds of screens, or the like of the image forming apparatus 100, and includes a touch panel, an alarm lamp, or the like for receiving input of operation from a user.

The separation driving circuit 440 is a driving circuit that moves the fixed roller 202 and the pressurizing roller 204 in a direction away from the application roller 201 or moves the fixed roller 202 and the pressurizing roller 204 to come into contact with the application roller 201 to form the nip portion 214 and the nip portion 215. As a method of moving the fixed roller 202 and the pressurizing roller 204 by the separation driving circuit 440, for example, a well-known method using a TR arm, a TR spring, and a TR cam as described in Japanese Unexamined Patent Application Publication No. 2012-196955 may be used.

Meanwhile, the CPU 401, the ROM 402, the RAM 403, the NVRAM 404, the external apparatus connection I/F 408, the network I/F 409, the application unit roller driver 411, the conveying roller driver 412, the sub-scanning driver 413, the sensor I/F 414, the inkjet head driver 420, the operation panel 430, and the separation driving circuit 440 are able to perform data communication with one another via a bus 410, such as an address bus or a data bus.

Further, the hardware configuration of the image forming apparatus 100 illustrated in FIG. 5 is one example, and the image forming apparatus 100 need not always include all of the components as illustrated in FIG. 5 or may include a different component.

### Control Operation of Application Roller

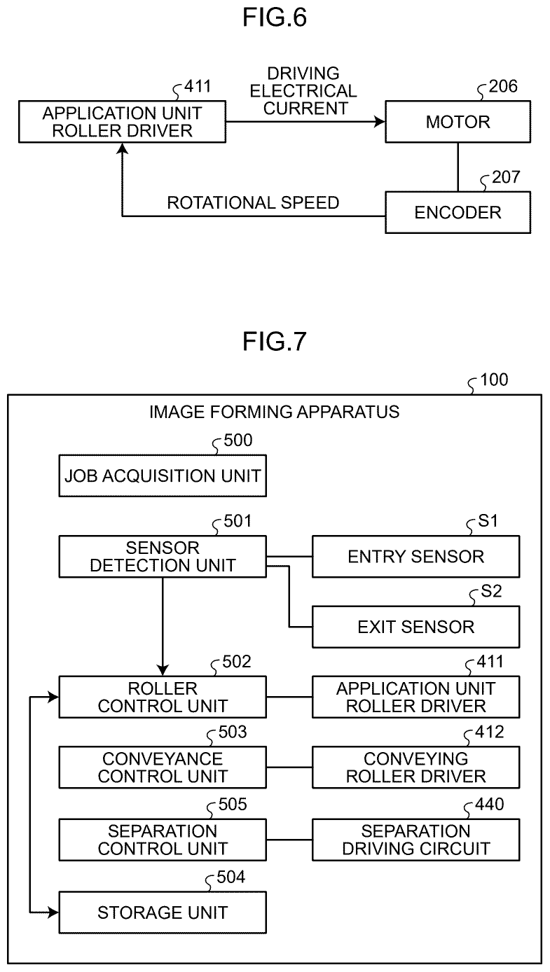

FIG. 6 is a diagram for explaining control operation the application roller of the application unit of the pre-application unit of the image forming apparatus according to one embodiment. The control operation of the application unit 108a of the pre-application unit 108 of the image forming apparatus 100 according to the present embodiment will be described below with reference to FIG. 6.

The application unit 108a further includes the motor 206 and an encoder 207 illustrated in FIG. 6.

The motor 206 is an electric motor for rotating the application roller 201, the fixed roller 202, the squeeze roller 203, and the pressurizing roller 204.

The encoder 207 is a sensor that detects a rotational speed of the motor 206. The encoder 207 transmits the detected rotational speed of the motor 206 to the application unit roller driver 411 (to be described later).

As described above, the application unit roller driver 411 rotates the motor 206 by outputting a driving electrical current to the motor 206 that rotates the application roller 201, the fixed roller 202, the squeeze roller 203, and the pressurizing roller 204. Further, the encoder 207 detects the rotational speed of the motor 206 and feeds the detected rotational speed back to the application unit roller driver 411. Specifically, the application unit roller driver 411 performs feedback control of comparing a set rotational speed (target rotational speed) and the rotational speed that is fed back from the encoder 207, so that it is possible to rotate the motor 206 at the target rotational speed and rotate the application roller 201, the fixed roller 202, the squeeze roller 203, and the pressurizing roller 204 at a desired line speed. Furthermore, it is preferable that the motor 206 is an AC servo motor that has high output and high responsiveness.

### Functional Block Configuration and Operation of Image Forming Apparatus

FIG. 7 is a diagram illustrating an example of a functional block configuration of the image forming apparatus according to one embodiment. With reference to FIG. 7, a functional block configuration and operation of the image forming apparatus 100 according to the present embodiment will be described.

As illustrated in FIG. 7, the image forming apparatus 100 includes a job acquisition unit 500, a sensor detection unit 501, a roller control unit 502 (first controller), a conveyance control unit 503, a storage unit (storage) 504, and a separation control unit 505 (second controller).

The job acquisition unit 500 is a functional unit that acquires job information that includes print data to be printed from an external apparatus or the like via the network I/F 409 or the like.

The sensor detection unit 501 is a functional unit that acquires a detection signal indicating that the medium is detected by the entry sensor S1 and the exit sensor S2, via the sensor I/F 414.

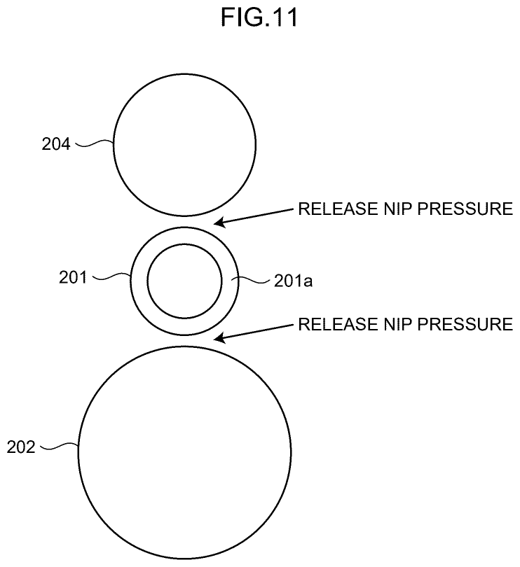

The roller control unit 502 is a functional unit that controls rotation of the application roller 201, the fixed roller 202, the squeeze roller 203, and the pressurizing roller 204 via the application unit roller driver 411. Specifically, the roller control unit 502 refers to a lookup table (to be described later) that is stored in the storage unit 504, and rotates the application roller 201 at an optimal line speed that is set in advance and that corresponds to a type of a medium being conveyed in the image forming apparatus 100. Further, to prevent occurrence of application unevenness due to a recess that is formed in the application roller 201, the roller control unit 502 rotates the application roller 201 for a predetermined rotation time during a period from acquisition of the job information by the job acquisition unit 500 to feeding of the medium to the application unit 108a. Operation of rotating the application roller 201 for the predetermined rotation time will be described in detail later with reference to FIG. 11 to FIG. 14.

The conveyance control unit 503 is a functional unit that controls rotation of each of the entry rollers 301 to 305, the exit rollers 306 to 309, the purge rollers 310 to 313, the re-entry roller 314, and the exit rollers 315 and 316 of the pre-application unit 108 via the conveying roller driver 412.

The storage unit 504 is a functional unit for storing the lookup table (one example of a table) in which the type of the medium and the optimal line speed of the application roller 201 are associated. The storage unit 504 is implemented by the ROM 402 or the NVRAM 404 illustrated in FIG. 5.

The separation control unit 505 is a functional unit that controls, via the separation driving circuit 440, operation of moving the fixed roller 202 and the pressurizing roller 204 in the direction away from the application roller 201 or operation of moving the fixed roller 202 and the pressurizing roller 204 such that the fixed roller 202 and the pressurizing roller 204 come into contact with the application roller 201 to form the nip portion 214 and the nip portion 215.

The job acquisition unit 500, the sensor detection unit 501, the roller control unit 502, the conveyance control unit 503, and the separation control unit 505 as described above are implemented by causing the CPU 401 illustrated in FIG. 5 to execute a program. Meanwhile, at least a part of the job acquisition unit 500, the sensor detection unit 501, the roller control unit 502, the conveyance control unit 503, and the separation control unit 505 may be implemented by a hardware circuit, such as a Field-Programmable Gate Array (FPGA) or an Application specific integrated circuit (ASIC).

Meanwhile, each of the functional units of the image forming apparatus 100 illustrated in FIG. 7 schematically indicates functions, and need not always be configured in the illustrated manner. In other words, each of the functional units of the image forming apparatus 100 need not always be configured as a specific software module including the blocks as illustrated in FIG. 7, but it is sufficient that the functions of each of the functional units are implemented as a whole by causing the image forming apparatus 100 to execute a program. For example, the plurality of functional units each of which is illustrated as an independent functional unit in the image forming apparatus 100 illustrated in FIG. 7 may be configured as a single functional unit. In contrast, it may be possible to divide the function of the single functional unit of the image forming apparatus 100 illustrated in FIG. 7 into a plurality of functions, and construct a plurality of functional units.

### Explanation of Operation of Pre-Application Unit of Related Image Forming Apparatus

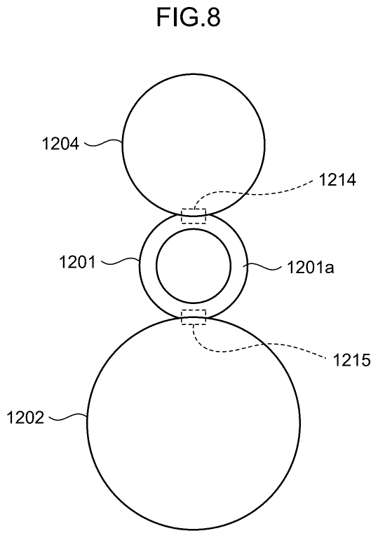

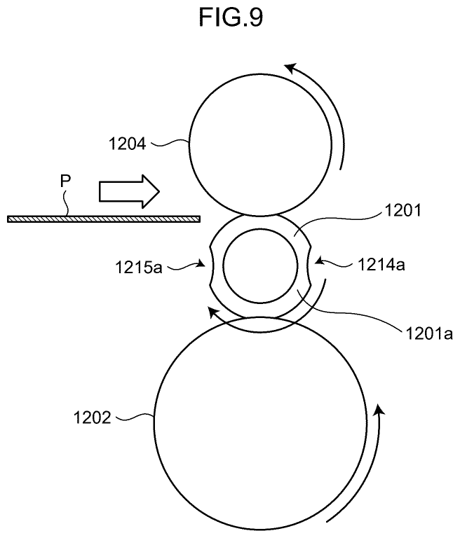

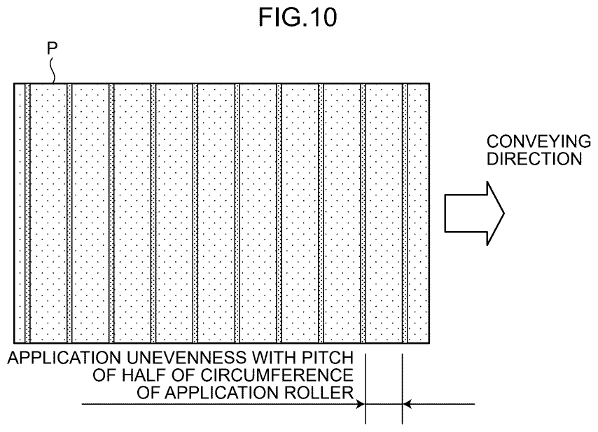

FIG. 8 is a diagram illustrating a preparation state before application of a treatment agent in an application unit of a pre-application unit of a related image forming apparatus. FIG. 9 is a diagram illustrating a state at the time of applying the treatment agent in the application unit of the pre-application unit of the related image forming apparatus. FIG. 10 is a diagram illustrating a state in which application unevenness in a banding manner occurs in a medium to which the treatment agent is applied by the pre-application unit of the related image forming apparatus. With reference to FIG. 8 to FIG. 10, operation of the pre-application unit of the related image forming apparatus will be described.

FIG. 8 illustrates configurations of an application roller 1201, a fixed roller 1202, and a pressurizing roller 1204 among components of the application unit of the pre-application unit of the related image forming apparatus. The application roller 1201 includes an elastic layer 1201a on an outer circumference thereof. In this configuration, a nip portion 1214 is formed between the application roller 1201 that includes the elastic layer 1201a on the outer circumference thereof and the pressurizing roller 1204, and a nip portion 1215 is formed between the application roller 1201 and the fixed roller 1202. Before acquisition of job information, similarly to the image forming apparatus 100 according to the present embodiment to be described later, the application roller 1201 is separated from the fixed roller 1202, the application roller 1201 is separated from the pressurizing roller 1204, and each of the application roller 1201, the fixed roller 1202, and the pressurizing roller 1204 is set to a non-rotating state.

Further, when the image forming apparatus acquires the job information, a paper feed unit feeds a medium, and therefore, it is needed to complete preparation for application operation of the application roller 1201 before the medium arrives at the application unit of the pre-application unit. To cope with this, in a related technology, as illustrated in FIG. 8, when the image forming apparatus acquires the job information, each of the fixed roller 1202 and the pressurizing roller 1204 comes into contact with the application roller 1201 such that the nip portion 1214 is formed between the application roller 1201 and the pressurizing roller 1204 and the nip portion 1215 is formed between the application roller 1201 and the fixed roller 1202 while each of the application roller 1201, the fixed roller 1202, and the pressurizing roller 1204 remains in a non-rotating state, and waits.

Furthermore, as illustrated in FIG. 9, when a medium P arrives at the application unit and the application roller 1201 performs the application operation, each of the application roller 1201, the fixed roller 1202, and the pressurizing roller 1204 starts to rotate. However, because of the wait in the state as illustrated in FIG. 8 as described above, recesses 1214a and 1215a are formed in two portions with a pitch of 180 degrees in the elastic layer 1201a of the application roller 1201 to which nip pressure is applied by the fixed roller 1202 and the pressurizing roller 1204 as illustrated in FIG. 9. Therefore, when the medium P is inserted to the nip portion between the application roller 1201 and the pressurizing roller 1204, an amount of the treatment agent increases in the recesses 1214a and 1215a as described above, so that, as illustrated in FIG. 10, application unevenness in a banding manner with a pitch of a half of the circumference of the application roller 1201 occur. In the image forming apparatus 100 according to the present embodiment, as will be described below, it is possible to prevent occurrence of treatment agent application unevenness in a banding manner as described above.

### Details of Operation of Application Unit of Pre-Application Unit of Image Forming Apparatus

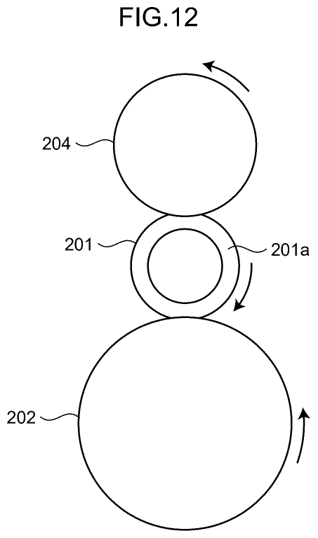

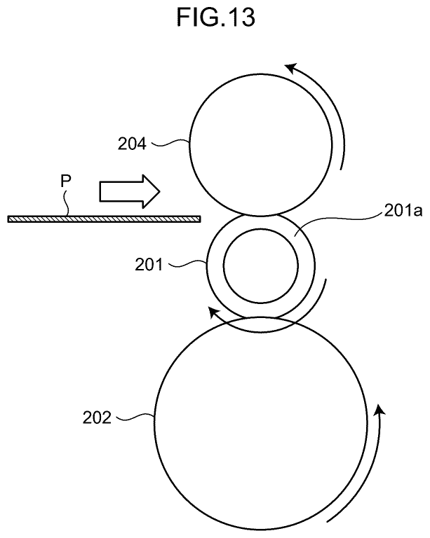

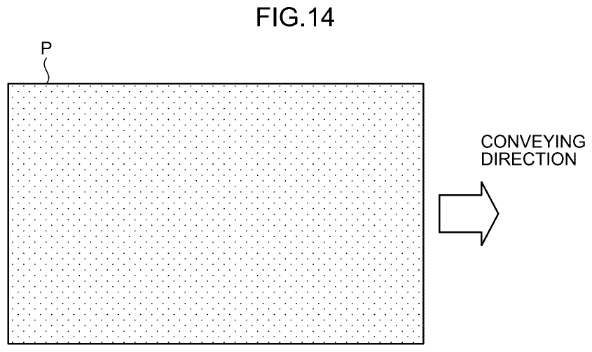

FIG. 11 is a diagram illustrating a non-operation state of the application unit of the pre-application unit of the image forming apparatus according to one embodiment. FIG. 12 is a diagram illustrating a preparation state before application of the treatment agent in the application unit of the pre-application unit of the image forming apparatus according to one embodiment. FIG. 13 is a diagram illustrating a state at the time of applying the treatment agent in the application unit of the pre-application unit of the image forming apparatus according to one embodiment. FIG. 14 is a diagram illustrating a state of a medium to which the treatment agent is applied by the pre-application unit of the image forming apparatus according to one embodiment. With reference to FIG. 11 to FIG. 14, operation of the application unit 108a of the pre-application unit 108 of the image forming apparatus 100 according to the present embodiment will be described in detail below.

In the application unit 108a of the pre-application unit 108 according to the present embodiment, before the job acquisition unit 500 acquires the job information, as illustrated in FIG. 11, the separation control unit 505 releases the nip pressure by separating the application roller 201 and the fixed roller 202 and releases the nip pressure by separating the application roller 201 and the pressurizing roller 204 via the separation driving circuit 440. Further, in this state, the roller control unit 502 maintains non-rotating states of the application roller 201, the fixed roller 202, and the pressurizing roller 204.

Subsequently, when the job acquisition unit 500 acquires the job information, similarly to the related technology, the paper feed unit 101 feeds a medium, and therefore, it is needed to complete preparation for application operation of the application roller 201 before the medium arrives at the application unit 108a of the pre-application unit 108. However, if the application roller 201 is rotated, the treatment agent that is supplied from the squeeze roller 203 and the fixed roller 202 is exposed to air, and when the treatment agent is exposed to air, moisture in the treatment liquid evaporates, so that viscosity of the treatment liquid increases and quality decreases. Furthermore, if the application roller 201 is rotated at a high speed, frequency at which the treatment liquid is exposed to air increases.

To cope with this, in the present embodiment, when the job acquisition unit 500 acquires the job information, the separation control unit 505 first brings each of the fixed roller 202 and the pressurizing roller 204 into contact with the application roller 201 to form the nip portion 214 between the application roller 201 and the pressurizing roller 204 and form the nip portion 215 between the application roller 201 and the fixed roller 202. Further, during a period from acquisition of the job information by the job acquisition unit 500 to feeding of the medium to the application unit 108a, as illustrated in FIG. 12, the roller control unit 502 rotates the application roller 201 for a predetermined rotation time. With this configuration, it is possible to prevent formation of a recess in the application roller 201 before the treatment agent is applied to the medium and eliminate a recess that is already formed, so that it is possible to prevent occurrence of treatment agent application unevenness in a banding manner and improve uniformity of application of the treatment agent.

Here, a degree of deterioration of the elastic layer 201a of the application roller 201 increases with increase in a usage time of the application roller 201, so that a time that is needed to eliminate the above-described recess that is formed in the elastic layer 201a also increases. To cope with this, the roller control unit 502, for example, it is preferable to determine the above-described rotation time based on the usage time of the application roller 201. With this configuration, it is possible to more reliably eliminate the recess in the application roller 201. Here, it may be possible to use, as the usage time, a cumulative time of processing time with respect to the job information that is acquired by the job acquisition unit 500 or a time that is proportional to the number of media that are used to process the job information, for example.

Furthermore, in this case, as illustrated in FIG. 12, the roller control unit 502 rotates the application roller 201, the fixed roller 202, and the pressurizing roller 204 for the above-described rotation time at a rotational speed that corresponds to a lower line speed than a line speed corresponding to the medium. Accordingly, by rotating the application roller 201, the fixed roller 202, and the pressurizing roller 204 at a low speed, it is possible to prevent increase in the viscosity of the treatment agent and prevent formation of recesses due to nip pressure that is applied by the fixed roller 202 and the pressurizing roller 204.

Moreover, as illustrated in FIG. 13, when the medium P arrives at the application roller 201 and the application roller 201 performs the application operation, the roller control unit 502 rotates the application roller 201, the fixed roller 202, and the pressurizing roller 204 at a rotational speed for the line speed corresponding to the medium P (a line speed that is defined by the lookup table that is stored in the storage unit 504). Here, it is sufficient to determine that the medium P arrives at the application roller 201 when the entry sensor S1 detects the medium P. With this configuration, the treatment agent is applied to the medium P while formation of the recesses in the application roller 201 is prevented, so that, as illustrated in FIG. 14, it is possible to prevent occurrence of treatment agent application unevenness in a banding manner.

As described above, in the pre-application unit 108 of the image forming apparatus 100 according to the present embodiment, the application roller 201 applies the treatment agent to a medium that is conveyed, the pressurizing roller 204 applies pressure to the application roller 201, the fixed roller 202 supplies the treatment agent to the application roller 201, the roller control unit 502 rotates the application roller 201 for the predetermined rotation time during the period from acquisition of the job information by the image forming apparatus 100 to arrival of the medium at the application roller 201. With this configuration, it is possible to prevent occurrence of treatment agent application unevenness in a banding manner with respect to the medium, and improve uniformity of application of the treatment agent.

Furthermore, in the pre-application unit 108 of the image forming apparatus 100 according to the present embodiment, the roller control unit 502 determines the above-described rotation time based on the usage time of the application roller 201. With this configuration, it is possible to more reliably eliminate the recesses in the application roller 201.

### First Modification

An image forming apparatus according to a first modification will be described below mainly in terms of a difference from the image forming apparatus 100 according to one embodiment as described above. In the present modification, operation of detecting rotational unevenness of an application roller caused by a recess that is formed in the application roller 201, and rotating the application roller 201 until the rotational unevenness is reduced will be described. Meanwhile, an overall configuration and a hardware configuration of the image forming apparatus according to the present modification are the same as those of the embodiment as described above.

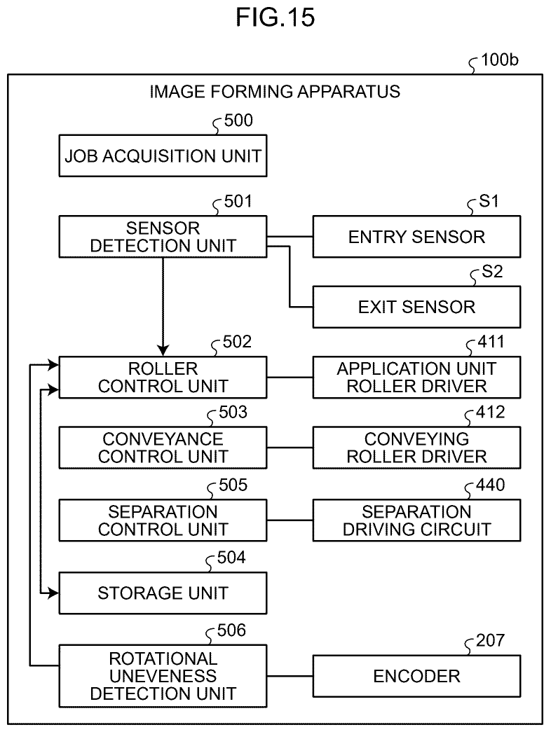

FIG. 15 is a diagram illustrating an example of a functional block configuration of the image forming apparatus according to the first modification. With reference to FIG. 15, a functional block configuration and operation of an image forming apparatus 100b according to the present modification will be described.

As illustrated in FIG. 15, the image forming apparatus 100b includes the job acquisition unit 500, the sensor detection unit 501, the roller control unit 502 (first control unit), the conveyance control unit 503, the storage unit 504, the separation control unit 505 (second control unit), and an rotational unevenness detection unit 506 (detector). Meanwhile, operation of the job acquisition unit 500, the sensor detection unit 501, the conveyance control unit 503, the storage unit 504, and the separation control unit 505 is the same as the operation described in the embodiment as described above.

As described above, when the application roller 201 rotates while the recesses are formed in the application roller 201 (the elastic layer 201a), contact states of the fixed roller 202 and the pressurizing roller 204 with respect to the application roller 201 are changed in the recesses, so that rotational unevenness occurs in the application roller 201. Therefore, in the present modification, operation of detecting rotational unevenness of the application roller 201 and rotating the application roller 201 until the rotational unevenness is reduced.

The rotational unevenness detection unit 506 is a functional unit that detects rotational unevenness of the application roller 201. The rotational unevenness detection unit 506 detects the rotational unevenness of the application roller 201 based on the rotational speed of the motor 206 that is detected by the encoder 207, for example. It may be possible to detect, as the rotational unevenness, an amount of change in the rotational speed of the motor 206, for example. Meanwhile, it may be possible to use an encoder that detects the rotational speed of the application roller 201, instead of using the encoder 207 that detects the rotational speed of the motor 206. Furthermore, the rotational unevenness detection unit 506 may use a dedicated sensor for detecting the rotational unevenness of the application roller 201, instead of using the encoder 207.

The roller control unit 502 rotates the application roller 201 for a predetermined rotation time during a period from acquisition of the job information by the job acquisition unit 500 to feeding of the medium to the application unit 108a, in order to prevent occurrence of application unevenness due to the recesses that are formed in the application roller 201. Here, the roller control unit 502 rotates the application roller 201 while using, as the above-described rotation time, a time that is needed for the rotational unevenness detected by the rotational unevenness detection unit 506 to fall at or below a predetermined value.

With this configuration, the application roller 201 is rotated until the rotational unevenness of the application roller 201 is reduced, so that it is possible to determine a degree of elimination of the recesses in the application roller 201, and it is possible to prevent occurrence of treatment agent application unevenness in a banding manner.

### Second Modification

An image forming apparatus according to a second modification will be described below mainly in terms of a difference from the image forming apparatus 100 according to the first modification as described above. In the present modification, operation of storing a time needed for rotational unevenness in the past to reduce and determining the rotation time of the application roller 201 based on the stored time. Meanwhile, an overall configuration, a hardware configuration, and a functional block configuration of the image forming apparatus according to the present modification are the same as those of the first modification as described above.

The roller control unit 502 stores, in the storage unit 504, a required time needed for the rotational unevenness detected by the rotational unevenness detection unit 506 to fall at or below a predetermined value since start of rotation of the application roller 201. In other words, the roller control unit 502 accumulates, in the storage unit 504, an actual result of the required time needed for the rotational unevenness to fall.

The roller control unit 502 rotates the application roller 201 for a predetermined rotation time during a period from acquisition of the job information by the job acquisition unit 500 to feeding of the medium to the application unit 108a, in order to prevent occurrence of application unevenness due to the recesses that are formed in the application roller 201. Here, the roller control unit 502 determines the above-described rotation time based on the required time needed for the rotational unevenness detected by the rotational unevenness detection unit 506 to fall at or below the predetermined value, that is stored in the storage unit 504, and rotates the application roller 201 for the rotation time.

In this manner, the rotation time of the application roller 201 is determined based on the required time needed for the rotational unevenness detected by the rotational unevenness detection unit 506 to fall at or below the predetermined value; therefore, by rotating the application roller 201 for a certain time that is based on past performance, it is possible to infallibly eliminate the recesses that are formed in the application roller 201. With this configuration, it is possible to prevent occurrence of treatment agent application unevenness in a banding manner.

Meanwhile, in the embodiment and each of the modifications as described above, when at least any of the functional units of the image forming apparatuses 100, 100a, and 100b is implemented by execution of a program, the program is provided by being incorporated in a ROM or the like in advance. Further, in the embodiment and each of the modifications as described above, the program that is executed by the image forming apparatuses 100, 100a, and 100b may be provided by being recorded in a computer-readable recording medium, such as a Compact Disc Read Only Memory (CD-ROM), a flexible disk (FD), a Compact Disk-Recordable (CD-R), or a Digital Versatile Disc (DVD), in a computer-installable or computer-executable file. Furthermore, in the embodiment and each of the modifications as described above, the program that is executed by the image forming apparatuses 100, 100a, and 100b may be stored in a computer that is connected to a network, such as the Internet, and may be provided by downlead via the network. Moreover, in the embodiment and each of the modifications as described above, the program that is executed by the image forming apparatuses 100, 100a, and 100b may be provided or distributed via a network, such as the Internet. Furthermore, in the embodiment and each of the modifications as described above, the program that is executed by the image forming apparatuses 100, 100a, and 100b has a module structure that includes at least any of the functional units as described above, and, as actual hardware, the CPU 401 reads the program from the above-described storage device (for example, the ROM 402, the NVRAM 404, or the like) and executes the program to load and generate each of the above-described functional units onto a main storage device (the RAM 403).

According to an embodiment, it is possible to prevent occurrence of treatment agent application unevenness in a banding manner with respect to a recording medium, and improve uniformity of application of the treatment agent.

Aspects of the present invention will be described below.
<1> A treatment agent solution application apparatus mounted on an image forming apparatus, the treatment agent solution application apparatus comprising:
   an application roller configured to apply a treatment agent to a conveyed recording medium;
   a pressurizing roller configured to apply pressure to the application roller;
   a supply roller configured to supply the treatment agent to the application roller; and
   a first control unit configured to rotate the application roller for a predetermined rotation time during a period from acquisition of job information by the image forming apparatus to arrival of the recording medium at the application roller.
<2> The treatment agent solution application apparatus according to <1>, wherein the first control unit is configured to determine the rotation time based on a usage time of the application roller.
<3> The treatment agent solution application apparatus according to <2>, wherein the usage time is one of a processing time with respect to the job information and a time that is proportional to a number of recording media used to process the job information.
<4> The treatment agent solution application apparatus according to <1>, further comprising:
   a detection unit configured to detect rotational unevenness of the application roller, wherein
   the first control unit is configured to rotate the application roller while using, as the rotation time, a time needed for the rotational unevenness detected by the detecting unit to fall at or below a predetermined value.
<5> The treatment agent solution application apparatus according to <1>, further comprising:
   a detection unit configured to detect rotational unevenness of the application roller; and
   a storage unit configured to store a required time needed for the rotational unevenness detected by the detection unit to fall at or below a predetermined value since start of rotation of the application roller, wherein
   the first control unit is configured to determine the rotation time based on the required time stored in the storage unit.
<6> The treatment agent solution application apparatus according to any one of <1> to <5>, wherein
   the first control unit is configured to rotate the application roller for the rotation time at a rotational speed corresponding to a lower line speed than a line speed corresponding to the recording medium during a period from acquisition of the job information by the image forming apparatus to arrival of the recording medium at the application roller.
<7> The treatment agent solution application apparatus according to <6>, wherein the first control unit is configured to rotate the application roller at a rotational speed corresponding to a line speed corresponding to the recording medium after the recording medium arrives at the application roller.
<8> The treatment agent solution application apparatus according to any one of <1> to <7>, further comprising:
   a second control unit configured to separate each of the pressurizing roller and the supply roller from the application roller before the image forming apparatus acquires the job information, wherein
   the first control unit is configured to render the application roller, the pressurizing roller, and the supply roller non-rotating before the image forming apparatus acquires the job information.
<9> The treatment agent solution application apparatus according to <8>, wherein the second control unit is configured to bring each of the pressurizing roller and the supply roller into contact with the application roller in response to acquisition of the job information by the image forming apparatus.
<10> An image forming apparatus comprising:
   the treatment agent solution application apparatus according to any one of <1> to <9>; and
   an ejection head configured to eject ink to the recording medium applied with the treatment agent by the treatment agent solution application apparatus, to form an image.

The above-described embodiments are illustrative and do not limit the present invention. Thus, numerous additional modifications and variations are possible in light of the above teachings. For example, at least one element of different illustrative and exemplary embodiments herein may be combined with each other or substituted for each other within the scope of this disclosure and appended claims. Further, features of components of the embodiments, such as the number, the position, and the shape are not limited the embodiments and thus may be preferably set. It is therefore to be understood that within the scope of the appended claims, the disclosure of the present invention may be practiced otherwise than as specifically described herein.

The method steps, processes, or operations described herein are not to be construed as necessarily requiring their performance in the particular order discussed or illustrated, unless specifically identified as an order of performance or clearly identified through the context. It is also to be understood that additional or alternative steps may be employed.

Further, any of the above-described apparatus, devices or units can be implemented as a hardware apparatus, such as a special-purpose circuit or device, or as a hardware/software combination, such as a processor executing a software program.

Further, as described above, any one of the above-described and other methods of the present invention may be embodied in the form of a computer program stored in any kind of storage medium. Examples of storage mediums include, but are not limited to, flexible disk, hard disk, optical discs, magneto-optical discs, magnetic tapes, nonvolatile memory, semiconductor memory, read-only-memory (ROM), etc.

Alternatively, any one of the above-described and other methods of the present invention may be implemented by an application specific integrated circuit (ASIC), a digital signal processor (DSP) or a field programmable gate array (FPGA), prepared by interconnecting an appropriate network of conventional component circuits or by a combination thereof with one or more conventional general purpose microprocessors or signal processors programmed accordingly.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA) and conventional circuit components arranged to perform the recited functions.

What is claimed is:

1. A treatment agent solution application apparatus mounted on an image forming apparatus, the treatment agent solution application apparatus comprising:
an application roller configured to apply a treatment agent to a conveyed recording medium;
a pressurizing roller configured to apply pressure to the application roller;
a supply roller configured to supply the treatment agent to the application roller; and
a first controller configured to rotate the application roller for a predetermined rotation time during a period from acquisition of job information by the image forming apparatus to arrival of the recording medium at the application roller.

2. The treatment agent solution application apparatus according to claim 1, wherein the first controller is configured to determine the rotation time based on a usage time of the application roller.

3. The treatment agent solution application apparatus according to claim 2, wherein the usage time is one of a processing time with respect to the job information and a time that is proportional to a number of recording media used to process the job information.

4. The treatment agent solution application apparatus according to claim 1, further comprising:
a detector configured to detect rotational unevenness of the application roller, wherein
the first controller is configured to rotate the application roller while using, as the rotation time, a time needed for the rotational unevenness detected by the detector to fall at or below a predetermined value.

5. The treatment agent solution application apparatus according to claim 1, further comprising:
a detector configured to detect rotational unevenness of the application roller; and
a storage configured to store a required time needed for the rotational unevenness detected by the detector to fall at or below a predetermined value since start of rotation of the application roller, wherein
the first controller is configured to determine the rotation time based on the required time stored in the storage.

6. The treatment agent solution application apparatus according to claim 1, wherein
the first controller is configured to rotate the application roller for the rotation time at a rotational speed corresponding to a lower line speed than a line speed corresponding to the recording medium during a period from acquisition of the job information by the image forming apparatus to arrival of the recording medium at the application roller.

7. The treatment agent solution application apparatus according to claim 6, wherein the first controller is configured to rotate the application roller at a rotational speed corresponding to a line speed corresponding to the recording medium after the recording medium arrives at the application roller.

8. The treatment agent solution application apparatus according to claim 1, further comprising:
a second controller configured to separate each of the pressurizing roller and the supply roller from the application roller before the image forming apparatus acquires the job information, wherein
the first controller is configured to render the application roller, the pressurizing roller, and the supply roller non-rotating before the image forming apparatus acquires the job information.

9. The treatment agent solution application apparatus according to claim 8, wherein the second controller is configured to bring each of the pressurizing roller and the supply roller into contact with the application roller in response to acquisition of the job information by the image forming apparatus.

10. An image forming apparatus comprising:
the treatment agent solution application apparatus according to claim 1; and
an ejection head configured to eject ink to the recording medium applied with the treatment agent by the treatment agent solution application apparatus, to form an image.
